(19) United States
(12) Patent Application Publication
(10) Pub. No.: US 2025/0363453 A1
(43) Pub. Date: Nov. 27, 2025

(54) SYSTEM AND METHOD FOR MAKING INTERACTIVE DECISIONS WITH INPUTS FROM SELECTED PARTICIPANTS

(71) Applicant: Darren Post, Clarkston, MI (US)

(72) Inventor: Darren Post, Clarkston, MI (US)

(21) Appl. No.: 19/290,335

(22) Filed: Aug. 4, 2025

Related U.S. Application Data
(63) Continuation-in-part of application No. 16/233,506, filed on Dec. 27, 2018.
(60) Provisional application No. 62/610,725, filed on Dec. 27, 2017.

(51) Int. Cl. G06Q 10/101

(52) U.S. Cl. CPC G06Q 10/101

(57) ABSTRACT

A system and computer implemented method to aid a user in making an informed decision by a user from one or more decision alternatives. The system and method generally is provided within an application hosted on an electronic device though companion applications in the form of a user portal and advisor/expert portal. Accordingly, users are able to solicit an advisor/expert for counsel on a various decision though the input of criteria related to the decision, wherein the application will control correspondence between the parties and provide quantitative and qualitative tools to aid in the user's analysis. The software can be hosted on a server and designed to enable effective communication between a user and one or more advisors. An artificial intelligence module can additionally provide decision alternatives based upon prior advisor feedback and analysis and user inputs.

### CROSS-REFERENCE TO RELATED APPLICATION

This U.S. Patent Application is a continuation-in-part of U.S. Nonprovisional application Ser. No. 16/233,506 filed Dec. 27, 2018, which claims priority to U.S. Provisional Application No. 62/610,725 filed Dec. 27, 2017, to the above-named inventors, the disclosure of which is considered part of the disclosure of this application and is hereby incorporated by reference in its entirety.

### FIELD OF THE INVENTION

This invention relates generally to an improved system and method to aid a user in decision making. The system and method is generally hosted on an electronic device to enable collaboration between a decision maker and multiple advisors allowing the decision maker to select the best option for a particular decision. Further, the system and method of the present disclosure enables an efficient qualitative summary of inputs from multiple advisors and quantitative algorithms for consolidating these inputs to aid the decision maker in determining their best option for a given decision. Advisors are selected from a virtual marketplace or selected by the user from the user's personal network of associates. Advisors can sign up to participate in a virtual marketplace hosted by the system. This enables a new “free” market for any advice services whether business, education, public, and service, etc.n

### BACKGROUND

Existing decision methods currently use one expert/advisor—one decision or a group of experts/advisors—one decision. These individuals or groups of experts consolidate their expertise and analysis to help recommend the best alternative or option for a given decision. In our personal lives, many individuals use a different model, wherein they get the advice of multiple people for important decisions. For example, if an individual's cardiologist recommended a heart transplant to resolve symptoms that they were experiencing, it is likely that they would seek a second or third opinion. Currently, this individual would be left to try to interpret multiple inputs qualitatively and try to make their best-informed decision. In today's world, it is difficult to engage multiple experts or people that one trusts to effectively or efficiently help in making decisions.

Companies, public organizations and individuals often engage a professional consulting firm to help with important decisions. These firms are paid a retainer and are the sole advisor on a given decision, often pitched to protect the consulting firm's proprietary decision methodologies. With the approach enabled by the system and method of the present disclosure, these companies would engage as many experts as they would like and focus them on specific decisions, rather than a rolling set of dialogues from a singular advisor. These consulting companies would then be rated on how well they provided decision specific input.

The system and method of the present disclosure fosters the shift from one advisor/consultant—one decision to multiple advisors—one decision. With multiple advisors engaged according to the system and method, decision quality is enabled to improve decision making by analyzing and interpreting criteria important to the problem and proposing options. Accordingly, if two or three consultants, using their own knowledge and tools provide similar option ratings and qualitative considerations, this would raise the decision maker's confidence in making the decision.

Therefore, there exists a need to improve the efficiency and cost of advice and counsel in the decision-making process through an integrated decision-making system and method. Preferably, this system and method is hosted on an electronic device or computing device and enables the collection of various inputs from multiple advisors to increase the veracity of a given decision analysis. The system and method can generally be hosted on a remote network and includes various reporting features related to various quantities and qualities of a given decision maker and user of the system and method.

### BRIEF SUMMARY OF THE INVENTION

In one aspect, this disclosure is related to a decision-making system and method to aid a decision maker in making a decision though a communicative portal hosted on an electronic device and within a given application.

In another aspect, this disclosure is related to a decision-making system and method that utilizes an application to connect users with advisors and experts in an efficient interface. Accordingly, the advisor/expert is able to communicate a given input on a decision back to a central database, preferably hosted on a “cloud” based network, to consolidate and calculate various parameters of a given decision. The application will utilize this advisor/expert input to generate decision reports to a given user to aid in making a decision.

In another aspect, this disclosure is related to application that allows a user to seek help and collaboration in making a decision from various contacts, acquaintances, and experts to provide the user with additional tools to aid in making the decision.

In another aspect, this disclosure is related to a decision marketplace hosted on an application and accessible through an electronic device, wherein various individuals and experts in a given area can utilize their expertise to provide a user with information and analysis related to a given decision. Accordingly, this service can be offered with or without a fee.

In another aspect, this disclosure is related to a system to aid a user of a system in making a decision associated with a specified subject. The system can include a decision module executable by a process or processing means, including but not limited to a phone, tablet, computer or server configured to receive a first input by a user using a specific user software communicatively coupled to the decision module. A user device can have a specified software specific to user requirement and an advisor device can utilize software specific to adviser requirements. The user device and advisor device can be communicatively coupled to a network or server. The user can provide on or more inputs needed to structure a decision output with the interface. At least a first response input by at least on advisor using an advisor specific software system which can assess the decision structure to support the user using a wireless cellular or local area network. A computing device can have a central processing unit and a memory that can host a cloud database or storage to receive and transmit information between a user and an advisor device.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a wireframe diagram of the various system and communication pathways of the system and method, according to the present invention;

FIG. 2 is a flow chart of the method steps of the various system and communication pathways of a user and an adviser, according to the present invention;

FIG. 3 is a general wireframe diagram of the adviser marketplace of the system and method, according to the present invention.

FIG. 4 is a wireframe diagram of the various system and communication pathways of the system and method, according to the present invention;

FIG. 5 is a flow chart of the method steps of the various system and communication pathways of a user, according to the present invention;

FIG. 6a is a flow chart of the method steps of the various system and communication pathways of one or more advisors, according to the present invention;

FIG. 6b is a flow chart of the method steps of the various system and communication pathways of one or more advisors, according to the present invention;

FIG. 7 is a chart providing a generated summary by an exemplary embodiment of a system of the present disclosure;

FIG. 8A is an illustration of a display for a decision objective definition for a user of an exemplary embodiment of the present disclosure.

FIG. 8B is an illustration of a display for a decision criterion for a user of for the decision definition of an exemplary embodiment of the present disclosure.

FIG. 8C is an illustration of a display for a decision alternative for a user of for the decision definition of an exemplary embodiment of the present disclosure.

FIG. 9A is an illustration of a display for a decision objective for an advisor for the decision definition transmitted by a user of an exemplary embodiment of the present disclosure.

FIG. 9B is an illustration of a display for a decision criterion for an advisor for the decision definition transmitted by a user of an exemplary embodiment of the present disclosure.

FIG. 9C is an illustration of a display for a decision objective rating interface for an advisor for the decision definition transmitted by a user of an exemplary embodiment of the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

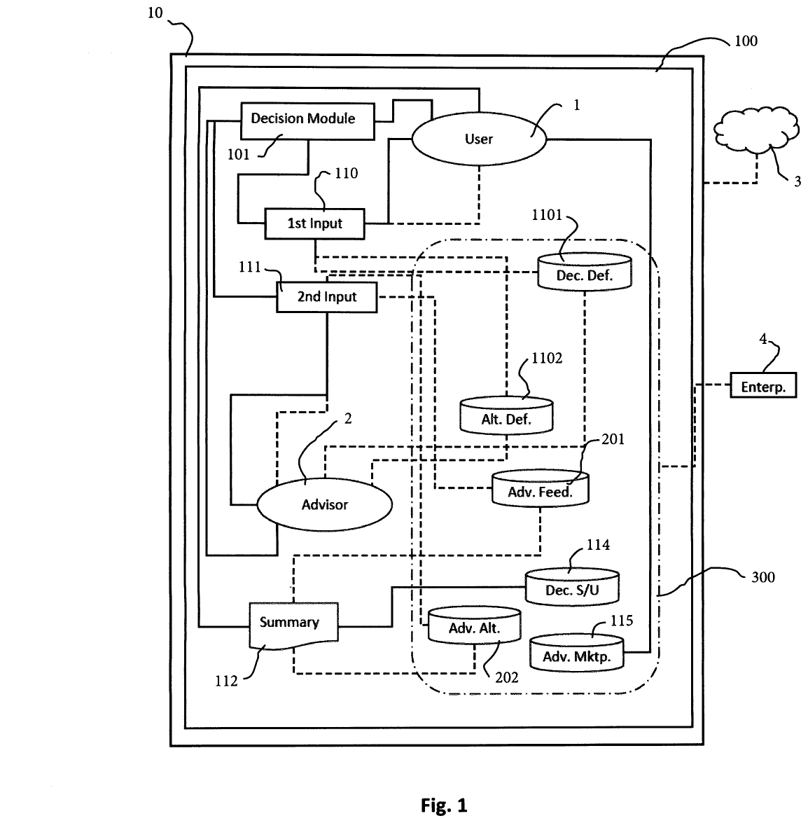

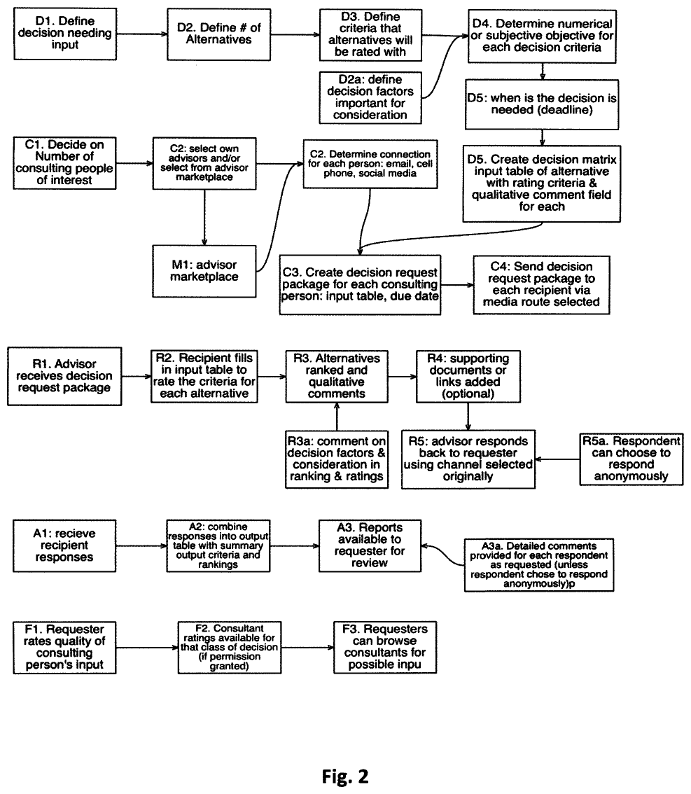

Referring now to FIGS. 1-3 of the decision-making system and method according to the present disclosure. Referring now to FIG. 1-2, in which, as illustrated, is the preferred configuration for a system 10 and method steps of making interactive decisions in accordance with the teaching of the present disclosure. The system 10 includes a decision module 101 hosted on a server 100 with the decision module 101 configured to receive a first input 110 in a first step by a user 1 of the system 10 and method in the form of a request related to decision. Accordingly, the user 1 enters a description of a decision within the first input 101 needing advising in step D1, through a keyed description by entering it into the first input 110 as displayed on a screen of a personal electronic device utilizing the system 10. This description of the decision is transmitted to a decision definition database 1101 for storage and later use by the advisor 2 in evaluation and the system 10 in compiling decision results.

At this first input 110 the user 1 may be prompted to enumerate alternatives to the decision needing advising at step D2 for consideration. These alternatives related to the decision of the user 1 are transmitted to an alternate definition database 1101 for storage and later use by the advisor 2 in evaluation and by the system 10 in compiling decision results. The definitions can be displayed in the summary provided by the system to the user.

Within the first input 110 of the system 10 and method the user 1 will prompted with various questions related to the decision that include, but are not limited to the questions shown in FIG. 2. Accordingly, the user 1 may enter their decision criteria shown as step D2a in they first input 110 corresponding to their specific decision factors that are important for their consideration. Further, if alternatives are to be considered by the advisor 2 related to the user 1 decision, the user 1 at step D3 will define criteria that these alternatives will be rated with.

Additionally, within the first input 110 the user 1 will determine and select a numerical or subjective objective decision criteria at step D4 for use by the advisor 2, and when and if a specific date or deadline is needed for completion within step D5. After this data and information is received at the first input 110 and transmitted to the appropriate database 1101, 1102, the system 10 generates an input table at step D6 that will be used by the advisor 2 for evaluation.

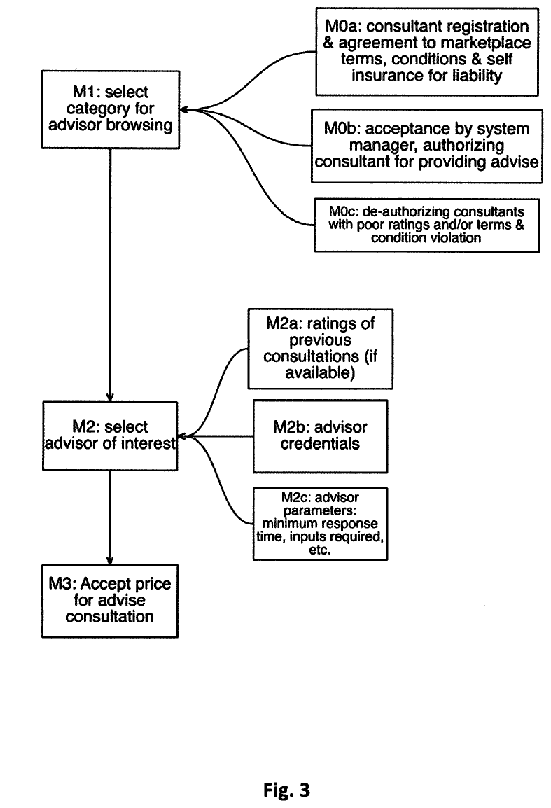

With the first input 110 the user 1 is able to further select from criteria related to the advisor 2 including but not limited to, the number of consulting people of interest or otherwise known herein as advisors 2 they would like utilized at step C1. Further at step C2, the user 1 may determine whether they would like to use a specific advisor 2 within their personal network or select an external advisor in an advisor marketplace, wherein they will be directed to the advisor marketplace at step M1 and shown in FIG. 3. Additionally, within step C2 the user 1 will select the preferred connection information, including, but not limited to, cell/mobile number, email, and social media address, that will be used to connect with a given advisor 2. At step C3, the system 10 generates a decision request package for each advisor 2 including the input table and due date that is then distributed to the advisor 2 at step C4 in the preferred media route selected by the user 1.

After information by the user 1 is completed at the first input 110, the selected advisor(s) 2 then receives a decision request package at step R1. Accordingly, a given advisor 2 will complete an assessment of the decision criteria based upon their knowledge and experience at step R2 for use by the system 10 at the second input 111. The advisor 2 provides feedback related to the decision in an assessment at the second input 111 that is communicated for storage to an advisor feedback database 201. If alternate decisions are requested as provided in method step R3, the advisor 2 will provide additional feedback in an assessment at the second input 111 that is communicated for storage in an advisor suggested alternatives database 202. Within the second input 111 the advisor may be prompted at steps R3, R3a, and R4 to provide information, including, but not limited to, rankings, comments, considerations, and optionally provide supporting documents or links. This advisor 2 feedback is transmitted from the relevant database 201, 202 for assembly by the system 10 into a summary 112 that is configured for compiling by the decision module 101 for communication to the user 1 for review and analysis at step A1. Prior to compiling, the advisor 2 may respond back to the user 1 with questions, feedback, or other items at step R5 and wherein the advisor 2 may do so anonymously at step R5a.

Advisor 2 feedback for use by the system 10 and decision module 101 compiling, including the alternatives, is presented on a table by ranking alternatives from 1 to n. Numerical criteria assessments and qualitative advantages (‘pros’) and disadvantages (‘cons’) are input at the second input 111 for each decision criteria to support the ranking rationale. Each decision criteria are assessed in the table that is provided as the summary 112 and communicated to a decision setup database 114 for assembly. For example, criteria may be assessed on a selected scale from 1 to 5 (1=low degree and 5=high degree), and quantitative assessments, such as fair market price or cost and probability of success, are entered as real numbers for later analysis.

If the advisor decides to provide a range estimate for real numbers, such as cost $100-200, that may be accepted and used later. Qualitative ‘pro’ and ‘con’ assessments are provided to complement the criteria scale ratings input by the advisor 2 and to provide a logical context for the user 1. The advisor(s) 2 can add any suggested alternatives and revise ranking and enter criteria data.

Further, the advisor(s) 2 may provide a decision rationale for entry alongside each alternative to describe their individual ranking rationale at the second input 111. Each decision criteria are assessed in the table and provided in the summary 112. For example, numerical criteria parameters such as cost, price, and time are entered as real numbers for later analysis. If the advisor decides to provide a range, such as cost $100-200, that is accepted and used later. Qualitative criteria inputs are input by the advisor as well. Advisors can add then add any suggested alternatives and revise ranking and enter criteria data throughout their ranking process.

Once the advisor(s) 2 has completed the decision input at the second input 111, which may be in the format of a data table for improved organization, they will make a selection to indicate that their input is complete. Accordingly, the advisor 2 has an opportunity to attach any files that would help support any alternative assessment (step R4). Completion of the input, is configured by the system 10 to transmits the decision input table or summary 112 back to the user 1 through a network back to the user 1 at a device that originated the decision inquiry. Further, in the case of multiple advisors 2 once decision inputs are received from all advisors 2 at the second input 111 the information is collated by the decision module 101 of the system 10 in the summary 112 at step A2 wherein the information in the form of the summary 112 is presented to the user 1 at step A3, representing a decision analysis that helps the user 1 compare alternative rankings to aid in making an informed decision and wherein the summary 112 may include detailed comments and input at step A3a.

After receipt and review of the decision generated by the system 10. The user 1 may rate the advisor 2 based upon objective and subjective criteria at step F1. The system 10 may collate and aggregate various advisor 2 reviews over time for various decision types at step F2, and wherein the user 1 is able to browse advisors 1 for future decision making at step F3 with the advisor 2 reviews of the users 1 stored on system 10 within an advisor marketplace database 115.

The system 10 and method steps enables individuals or organizations to acquire decision-by-decision input from multiple advisors in order to select the best option for a particular decision. This is a significant change as the current industry approaches contracting consultants in exclusive arrangements to provide counsel on select decisions. Further, the system 10 and method enable expanded access to thousands of businesses who can't afford expert advice from high caliber organizations. The rating of advisors 2 features of the system 10 and method steps at F2-F3 enables the creation of a new breed of advisor firms and individuals, enabled by this disclosure.

The system 10 and method steps are configured to enable the efficient qualitative summary 701 of inputs from advisors 2 or experts and provide a new quantitative method for consolidating advisor input to take the subjectivity out of comparisons by users 1.

The system 10 and method is preferably executed on a mobile device, such as a cellular telephone, through a software application (APP) configured to communicate the various decision parameters and options from users 1 to advisors 2 to enable a practical and efficient user-to-advisor interface. Advisors 2 may use the mobile device APP of the system 10 and method to communicate their input at the second input 111 back to a central server 100 that may be hosted on a cloud 3, wherein the system 10 is accessible across multiple computing platforms and devices. Accordingly, the system 10 database structures are configured for using a multipage spreadsheet or similar tool to consolidate and facilitate back room calculations and ratings of the system 10. The unique analytical method of the system 10 combines and “normalizes” these inputs and consolidates them appropriately; this removes the interpretation from the determination by a user 1 of which option or alternative is superior.

As is seen in FIG. 1-7, within the process of formulating a decision for evaluation by a user 1 of the system 10 and method of the present disclosure the user 1 may select a given advisor 2 from the advisor marketplace at step C2. Accordingly, the system 10 includes a marketplace (FIG. 3) providing various consultant types to sign up as the advisor 2 in a dedicated Advisor Marketplace portal of the advisor portion of the system 10 APP. The advisors 2 are enabled to categorize their expertise and cost per decision. Accordingly, the system 10 APP provides a fundamental change in how advice is provided by traditional advice-based industries to provide services directly to users 1. A given user 1 is in control, free to choose the right consultant they select for a given decision. Further, the Advisor Marketplace provides the user 1 a platform to rate the advisor 2 according to various criteria, including, but not limited to, the effectiveness, and the quality of service received. This rating is then utilized by additional users 1 for future services. Accordingly, this Advisor Marketplace enables a new “free” market for any advice services whether business, education, public service, etc. that today is generally operating under the antiquated retainer fee and single advisor model that is often not specific to any particular decision.

As is specifically shown in FIG. 3, the Advisor Marketplace of the system 10 includes various method steps to enable its features. At a first step M1, the user 1 is able to select a given category for a decision and enabled to browse for specific advisors 2 within the given category. Within this selection at M2, the user is able to view various elements related to the advisors 2, including but not limited to, previous ratings (if available) (M2a), credentials (M2b), minimum response time, input required, price, and various other items related to a given advisor 2 (M2c). The user 1 is then able to select the advisor 2 they would like to consult for their given decision at step M3.

Concurrent with advisor 2 selection by the user 1, the Advisor Marketplace enables a given consult to register as an advisor 2 for placement within the marketplace at step M0a. The advisor 1, will need to provide various information related to their expertise, including but not limited to, experience, certifications, education, specialties, knowledge, and consent to terms, conditions, and liability limitations. The system 10 may include system administration to accept and remove a given advisor 2 for placement within the Marketplace and removal from the Marketplace at steps M0b and M0c.

Similar to the Marketplace, the user 1 of the system 10 and method will utilize a user based portal generally through the first input 110 corresponding to portion of the APP of the system 10 and method to accesses and further processes their input for a given and requested decision into the summary report 112 that presents all qualitative inputs and does a quantitative consolidation using the “Maximum-Minimum Expected Value Utility” calculations that are described below.

The system 10 and method of the present disclosure will utilize back end processing on the server 100 that may include an algorithm to generally aid in the rating of options, generally referred to as the maximum-minimum expected value utility algorithm. The maximum-minimum expected value utility algorithm derives a marginal utility for option rating factors that are defined in the APP dialogue with the user 1 and gathered from the APP dialogue with multiple expert advisors 2 to enable a quantitative ranking of options for a given decision. The data is structured during the users 1 initial decision setup at the first input 110 and calculated within the decision module 101 utilizing parameters including, but not limited to, a criteria 1 rating, a criteria 2 rating through the user APP. The advisors 2 will rate these criteria, provide a fair market price or cost and probability of success using the advisor 2 portal of the APP.

For a given decision, each advisor's 2 option ratings are converted into an expected value (EV) option utility by dividing the criteria ratings (e.g. an integer from 1 to 5) and divided by the fair market price. The expected value is calculated by adding the advisors 2 option utilities together and multiplied by the probability of success. This establishes quantitative ratings that can be compared across numerous advisors 2 on the same basis.

Now that comparable quantitative ratings for each advisor 2 and for all options are available, the algorithm determines the minimum EV utility value for each option. The next step is to rank the options by minimum EV utility values. The maximum of these minimum EV utility values is thus the highest value option, followed by the next highest value. This method ranks the options by dominance established by the selected advisors 2 knowledge about the options and their assessment of how these options meets the user's decision needs.

Accordingly, the maximum-minimum expected value utility calculation within the utility is as follows:

$$EV option utility = probability of success X ( option utility ( a ) + option utility ( b ) + … Option utility ( n ) )$$

$$Where Option utility ( decision , advisor ) = critera ( n ) / fair market price$$

$$Minimum utility ( option ) = lowest value ( EV option utility ( option ( a ) ) .$$

$$EV option utility ( option ( n ) )$$

$$Rank options by maximum ( minimum utility ( option ( a ) ) . option ( n ) )$$

$$Highest max - min EV utilities is most desirable option and lowest is the least desirable option .$$

The EV max-min utility ranking summary is displayed on an APP screen, alongside all option qualitative pro's and con's in the summary 112 including raw inputs. This gives the user the best summary by providing qualitative and quantitative information for their decisions.

To improve the veracity and robustness of the system 10 and method steps, the system 10 and server 100 architecture may be configured to enable separate servers or systems for users 1 and advisors 2. Accordingly, one configuration may segregate the decision definition database 1101, the alternate decision definition database 1102, the advisor feedback database 201, the advisor alternate feedback database 202, the decision setup database 114, and the advisor marketplace database 115 on a separate server 300. This server 300 may be hosted on the cloud 3 or alternately may be part of an enterprise 4, wherein the data of the system 10 is controlled by a central system operator. Various alternate configurations for the system 10 and method steps may be utilized without departing from the spirit of the present disclosure.

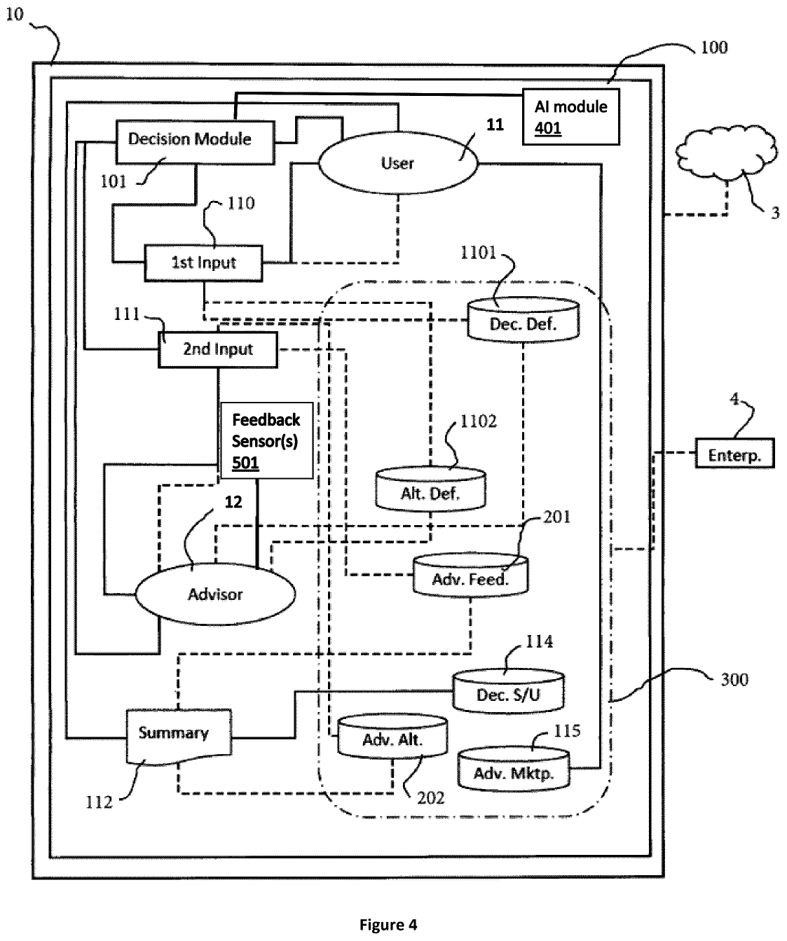

As shown in FIGS. 4-7, in one exemplary embodiment, a system and a computer-implemented method for aiding a user to make a decision associated with a predetermined subject can include a user device 11 and an advisor device 12. A decision module 101 executable by a processor configured to receive a first input by the user device 12 and at least one second input by at least one advisor device 12 via a network communicatively coupled to the processor. At least one computing device can include a central processing unit and a memory communicatively coupled to the network. The computing device can execute one or more programs of the decision module. The decision module can have one or more executable programs including for receiving from the user device at least one decision criterion input and at least two decision alternative inputs. The system can then request advice from one or more advisors on the first input. An updated decision alternative assessment based on a plurality of inquiries associated with the subject can be generated. The updated decision alternative assessment based upon the input criterion to the user can be sent by outputting a plurality of questions related to the first input of the user device. An updated first input by the user can be associated with the answers to the one or more questions that contribute to establishing at least one advisor decision criterion assessment. The updated first input can be sent to a decision definition database to determine at least one advisor decision alternative rating based one or more user inputs.

The advisor decision criterion can be sent to one or more advisors. A display communicatively coupled to a user device 11 can prompt the applicable advisor and advisor device 12 to select a rating for the decision alternative inputs in the form of decision criteria scales. The system can receive from one or more advisor devices 12 at least on advisor feedback in the at least one second input. The advisor feedback can be based on the at least one advisor criterion and a review of the relative at least two decision alternatives based on one or more provided inputs by a user and the at least one advisor assessment based upon user provided decision criterion. The advisor feedback can be transmitted to an advisor feedback database for updating the stored advisor feedback associated with the subject. The system can generate a prioritized advice output based on the stored advisor feedback of the advisor feedback database. The prioritized advice output can include a plurality of decision alternative assessments. Each decision alternative assessment can include a chart or graph 720 that can numerically ranked based on a composite of plurality of decision alternative criterion ratings. An expected value of utility can be generated from the criterion ratings value per fair market price dollar and a probability of success can be derived for each alternative assessment. This provides a standardized rating to provided an equal comparison between the different advice outputs based upon the inputs of the user and advisors. The prioritized advice output can be transmitted via the network to the user device. The prioritized advice output can include a quantitative rating and a qualitative feedback 710. A chart can be displayed showing a comparative chart between the plurality of decision alternatives. Quantitative feedback 720 can further be provided by generating a composite ranking based upon the alternative inputs of the advisor, decision criterion (i.e. probability of success, price, etc.), AI module, and/or biometric sensor(s).

Some exemplary embodiments of a system 10 of the present disclosure can optionally include an artificial intelligence (“AI”) module 401 configured to provide decision deep learning neural network model to disassociate factors from decisions and/or objective. The AI module can be comprised of one or more neural networks and algorithms to provide feedback and analysis to the user. The system can utilize a user device 11 and an advisor device 12. The devices can include a transceiver to allow communications between other devices via a network. The system can include specific software applications or modules designed specifically for users 1 or advisors 2. A first software can be for a user device and a second software module can be for an advisor device 12. The AI module 401 can be communicatively couple to one or both of the user device 11 or advisor device 12.

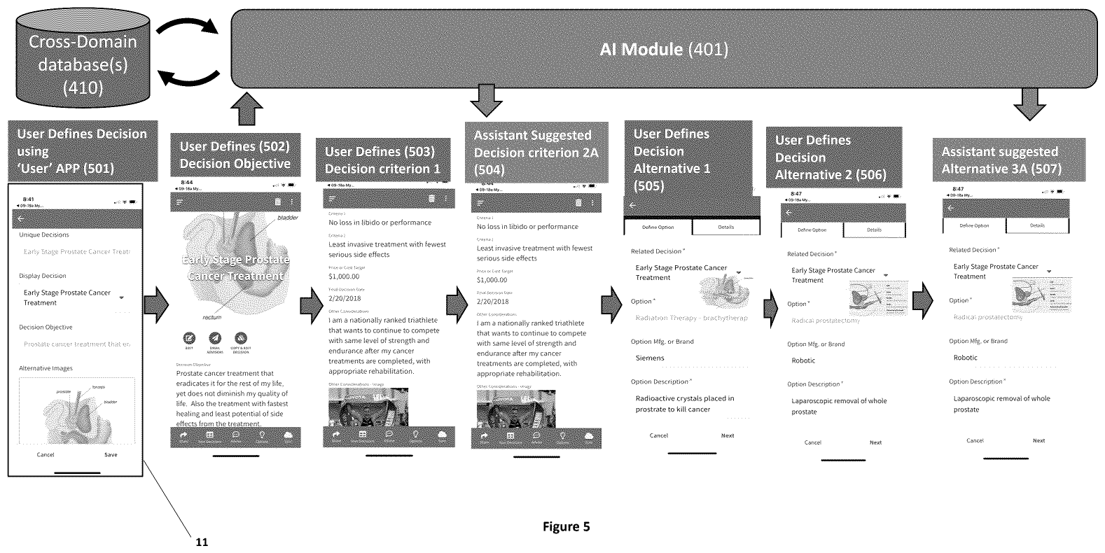

The AI module can identify decision criteria or additional inputs not considered and possible alternatives that may fit with the decision objective, looking at similar types of decisions across various domains. The AI assistant will be a deep learning neural net that will fed information from the web across various related topical domains. An AI module 401 can further generate suggestions to improve a user's decision setup into the system as shown in FIG. 5. The AI module 401 can be stored within the decision module 101 or alternatively communicatively coupled to the decision module 101. The AI module 401 can provide and/or generate suggestions to improve a user's decision setup or inputs for an advisor. The Ai module can identify decision criteria not originally considered by the user and provide possible alternatives that may fit with the decision objective requirements set forth by the user. The AI module can comb various domains and databases as well as previously provided decisions provided by advisors. Prioritized advice output can be stored on a database an further utilized by the AI module for future decision alternatives upon similar user inputs into the system.

Additionally, the system can obtain user feedback as to the option chosen that can similarly be used by the AI module 401 for future suggested decision criterion and suggested alternatives. The marketplace database 115 can further be used to store the advisor rating in association with the advisor and associated feedback advice. A the decision module is programmed execute on or more of the following: receive an alternative from the user in the first input, transmit the alternative to an alternative definition database, transmit the alternative to the advisor, receive from the advisor an advisor suggested alternative in the at least one second input, transmit the advisor suggested alternative to an advisor suggested alternatives database, and/or execute a command to provide the advisor suggested alternative in the readable summary 700, wherein the decision modules provides an expected value in the form of a numerical value to establish a quantitative rating of the alternative. Upon a user 1 providing an input for a decision criterion, the AI module can implement a search function to any applicable database including the marketplace database and cross-domain database to identify previously decision criterion related to the decision criterion input. The AI module can then provide additional suggested decision criterion and/or alternatives to the user through the user device. Additionally, the AI module may generate non-advisor based feedback based upon previous advisor feedback to similar or the same decision criterion previously presented by past users.

The system can generally be a cloud-based server accessible through a wireless networks by one or more user devices and advisor devices. The advisor marketplace database, the decision definition database, the advisor feedback database, the decision setup database, the alternative definition database, and the advisor suggested alternative database are hosted on a second server and controlled by an enterprise

The system 10 can be utilized for various types of decision criteria areas including but not limited to medical, health, legal, dental, automotive services, aerospace services, home construction, commercial building, home repair, etc.). The AI module 401 can include or be communicatively coupled to one or more cross-domain databases 410 or service communicatively coupled to the internet. The database 410 can regularly be updated and communicatively coupled to other databases that can train the AI module. As one illustrative example, a user may have a health condition (i.e. prostate cancer) and is considering radiation therapy such as photon radiation. The AI module may identify and recommend another alternative treatment, such a proton radiation being used for dental cancer treatment, that could satisfy the decision objective. It may also suggest decision criteria such as minimal harm to surrounding organs from other cases such as a surgery procedure.

In some exemplary embodiments, a user using a user specification application/software can define a decision that it needs advise or feedback on as shown in FIG. 5. In one exemplary embodiment, a user can provide a first input (Step 501). The input can use a menu to enter in the type of decision it desires a recommendation for a solution to the decision. In some exemplary embodiments, this can be used for medical advice such as cancer treatments or treatments for various illnesses. The user can then put in an additional or second input to further define the decision objective (Step 502). For instance a user can state they want a cancer treatment that will not dimmish long term quality of life or weight the potential side effects as being minimal. Similarly, other potential decision definitions could be based upon cost or success rate.

The AI module can include one or more algorithms that can assess the potential inputs by the user. In some exemplary embodiments, the AI module can search one or more databases or the internet to review the potential decision input by the user and can further assess the second decision criteria or input by the user. The AI module can then generate an output to the user that provides an additional criterion that may be used and inputted by the user as an additional criterion for consideration of the defined decision input. A user can provide additional inputs to further define potential solutions or alternatives for the desired decision input (Steps 505 and 506). The AI module 401 can further provide and generate additional decision alternatives (Step 507) that may not have been known to the user or system prior to the user's input. These decisions alternatives can be transmitted to an advisor 2 via the network or directly to an advisor device 12.

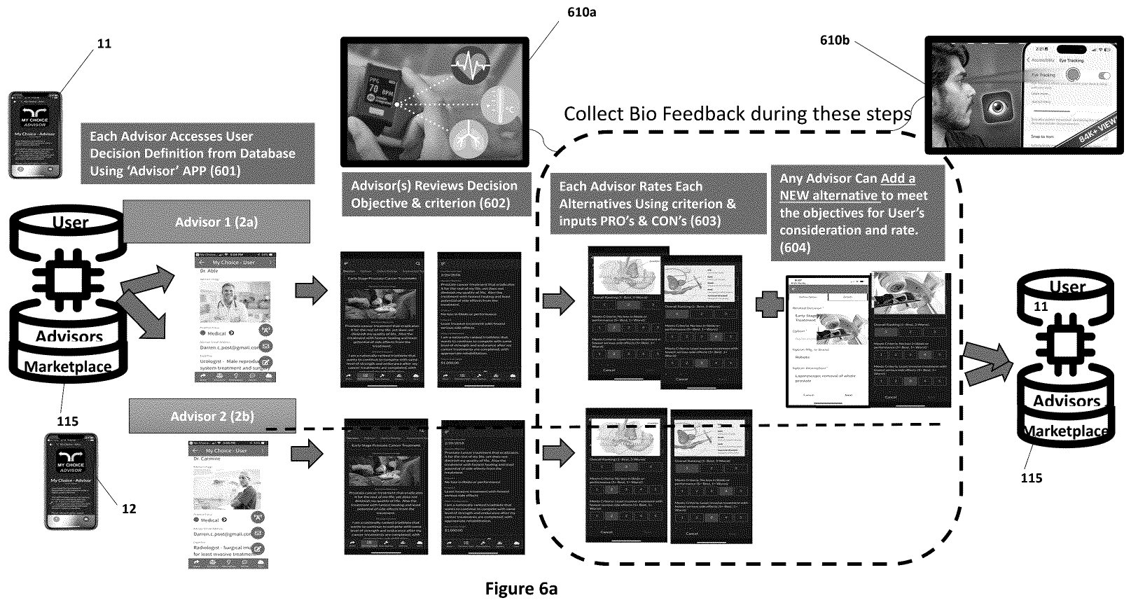

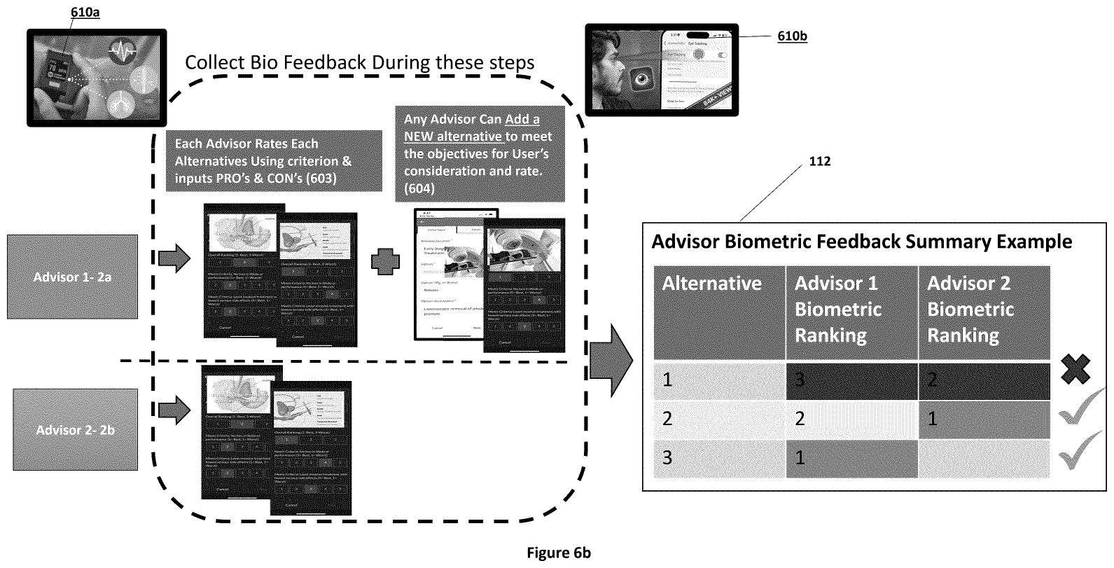

The system 10 can further include one or more sensors 610 that can be communicatively coupled to or proximate to an advisor 2. In some exemplary embodiments, the sensors can be obtain and provide biometric feedback from the one or more advisors during the advisors decision assessment when providing feedback. The sensors can include any suitable sensors including wearable sensors that can capture biofeedback such as heart rate, body temperature, blood oxygen. These items can be obtain through smart watch type apparatuses that can be communicatively connected to the system and advisor application software. Additionally, other types of biofeedback sensors 610 including cameras or webcams can obtain additional data such as eye movement and other biofeedback that can be utilized by the system when ranking the various advisor feedbacks to a user. Biometric readings will be captured while advisors complete the decision criteria ratings and when advisors are ranking alternatives and entering their pro's/advantages and con's/disadvantages for each alternative. Similarly, the AI module can utilize these biometric inputs along with the advisor inputs for further assessment. As shown in FIG. 6b, a user can provide assessment of three various alternatives by revising the alternatives and providing rankings. During the assessment step, the one or more sensors 610 can monitor and generate an assessment based on the biofeedback as to the potential alternatives. Based on the biometric feedback, the system can rank the alternatives provided by one or more advisors. The biometric feedback can be analyzed through a biometric analysis algorithm or other program that can quantify biometric reactions during the advisors assessments. Additionally, this data can be further provided to the AI module for further use in future assessments and feedback alternatives.

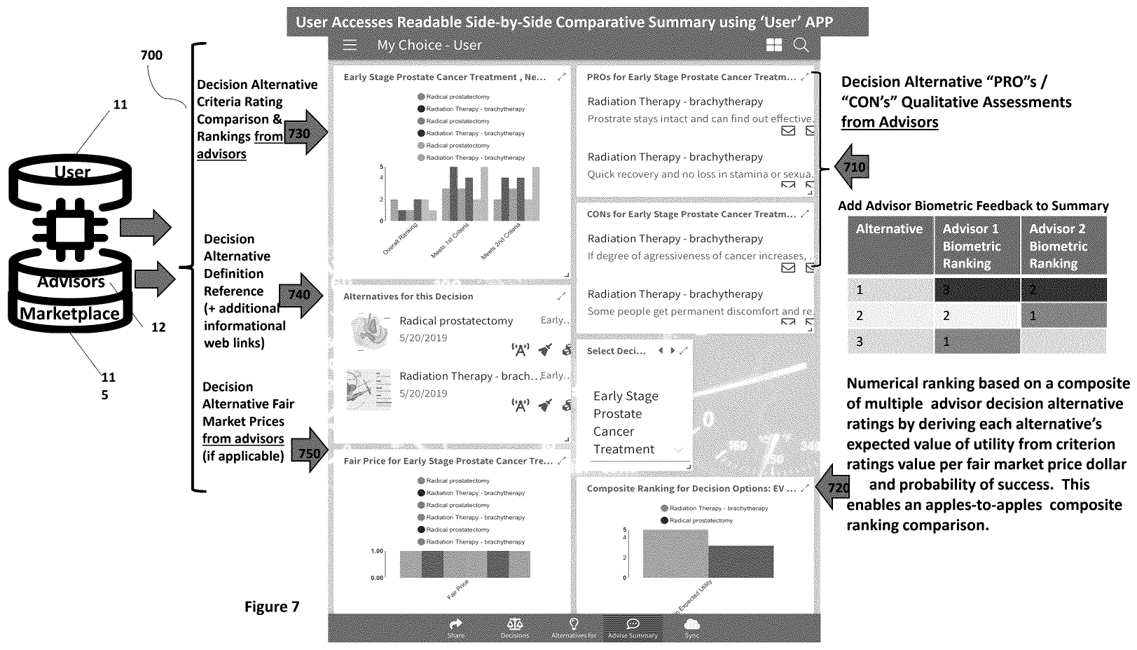

As shown in FIG. 7, one or more Advisors 2a,b can access through the network on or more decision alternative requests proposed by a user 1. Advisor 2 feedback for use by the system 10 and decision module 101 compiling, including the alternatives, is presented on a display via user device or generated via email to be send to the user device 11 as a summary. The generated feedback can include qualitative feedback 710 that provides detail context as to the proposed alternatives by the one or more advisors. The AI module can process the one or more alternative inputs by the one or more users to generate a textual summary of the qualitative feedback to the user. Quantitative feedback 720 can be provided by the system to the user by providing numerical rankings. A composite ranking can be generated on a table by ranking alternatives from 1 to n. Numerical criteria assessments and qualitative advantages (‘pros’) and disadvantages (‘cons’) are input at the second input 111 for each decision criteria to support the ranking rationale. Each decision criteria are assessed in the table that is provided as the summary 112 and communicated to a decision setup database 114 for assembly. For example, criteria may be assessed on a selected scale from 1 to 5 (1=low degree and 5=high degree), and quantitative assessments, such as fair market price or cost and probability of success, are entered as real numbers for later analysis. If the advisor decides to provide a range estimate for real numbers, such as cost, that may be accepted and used later. The generated qualitative ‘pro’ and ‘con’ assessments are provided to complement the criteria scale ratings input by the advisor 2 and to provide a logical context for the user 1. The advisor(s) 2 can add any suggested alternatives and revise ranking and enter criteria data. Additionally, the sensors 610 can be utilized during the rating process of the advisors and when an advisor decides to add another alternative (Steps 603 and 605). The biometric feedback can be quantitatively assigned a value and additionally be used when generating the numerical rankings based upon the advisors biometric.

The summary can include decision alternative criteria 730 rating comparison and rankings from advisors. The generated rankings can be multiple to provide rankings based on the overall ranking, a first decision criterion, and a second decision criterion to provide a user a visual display as to the rankings of each alternative based upon the one or more designated criterion by the one or more advisor inputs. Decision alternative definition references 740 can similarly be generated by the system to provide definitions of each of the proposed decision alternative. The AI module can further generate links to additional information or relevant articles related to each of the decision alternative definitions references. Additionally, decision alternative fair market prices can be provided. The prices can be provided from inputs by the advisors or generated by the AI module based upon one or more database references for related pricing on the relevant alternatives.

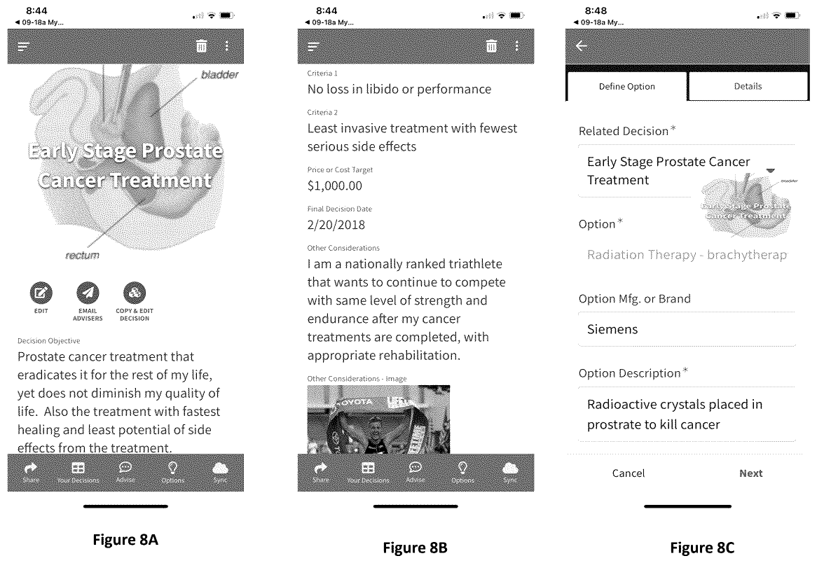

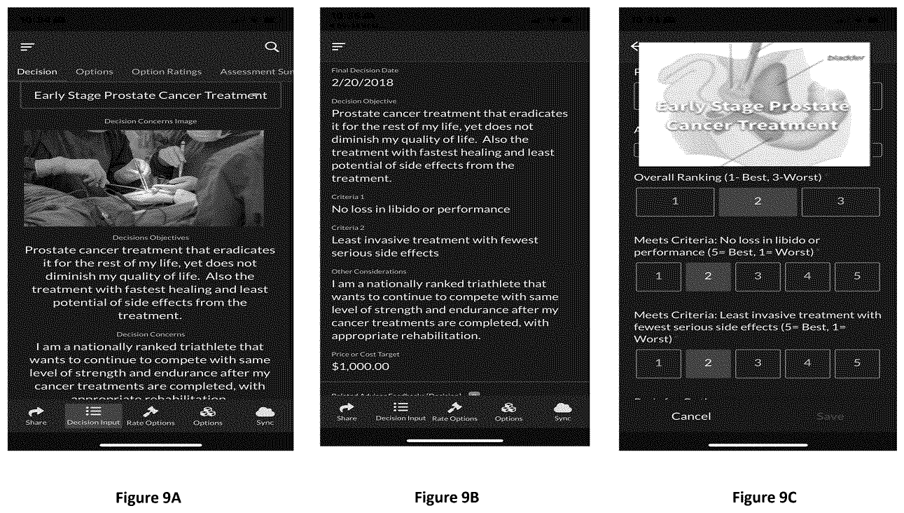

As shown in FIGS. 8A-C, a user can interface with the system through a display to select a decision objective. The user then can input various decision criteria that the user desires to be accounted for by an advisor and/or the AI module. The user can similarly provide one or more alternatives for the decision objective. Optionally, the AI module can generate a related alternative not generated by the database or user. FIGS. 9A-C provide corresponding graphical displays for advisors upon the input of a user. The advisor can view the decision definition and criteria submitted by the user. The advisor can then use a graphical interface (FIG. 9C) to provide feedback and ranking for each of the related alternatives. They system can analyze and normalize the input by one or more advisors as well as optionally and alternative assessment generated by the AI module.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of the appended claims.

The system may interact with other devices and networks to communicate with the client(s). Hardware may include video cameras, microphones, video players, cameras, and accessing other apps or software for communicating and transferring data to update the display output. The output may then be modified with hardware data capture information. Such as using the camera to capture video and displaying the video in real-time on the output display, including audio played over speakers.

Other networks may be in communication with the system, such as a network of service providers and information related to providing services. Other networks and other applications, such as accessing a calendar to determine availability and scheduling the service appointment. Navigation may be accessed to help with directions to where the service is to be provided.

The user may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other network types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A system for providing scoring a user-prompted decision, comprising:
a user device for providing a first decision criterion input;
an advisor device for providing a decision alternative input;
a decision module, wherein the decision module can be communicatively coupled to the user device and the advisor device;
an AI module communicatively coupled to the decision module, wherein the AI module is communicatively coupled to one or more databases;
wherein a user provides the decision criterion input, and the AI module can generate one or more additional decision criterion inputs based upon the first decision criterion inputs, wherein a user provides at least a first decision alternative to be transmitted to an advisor device through the decision module.

2. The system of claim 1, further comprising at least one sensor communicatively coupled to the advisor device to obtain biometric feedback from the advisor providing advisor feedback on the decision criterion for the decision alternative input.

3. The system of claim 2, wherein the biometric feedback is analyzed one or more algorithms of the system to provide a feedback summary to the user based upon the decision alternative inputs.

4. The system of claim 1, wherein the decision module decision module is programmed to:
receive an alternative from the user in the first input;
transmit the alternative to an alternative definition database;
transmit the alternative to the advisor;
receive from the advisor an advisor suggested alternative in the at least one second input;
transmit the advisor suggested alternative to an advisor suggested alternatives database.

5. A computer implemented method to aid a user of the system in making a decision associated with a subject:
providing a decision module executable by a processor configured to receive a first input by the user from a mobile device and at least one second input by at least one advisor via a network communicatively coupled to the processor; and
a computing device comprising a central processing unit and a memory communicatively coupled to the network, the computing device executing the decision module, which is programmed to:
receive from the user at least one decision criterion input and at least two decision alternatives inputs;
requesting advice based on the subject in the first input;
determine, by the decision module and associated with the at least one decision criterion from the user, an updated decision alternative assessment based on a plurality of inquiries associated with the subject;
send the updated decision alternative assessment criterion to the user, by outputting a plurality of questions related to the first input, wherein an updated first input by the user is associated with answers to the questions that contribute to establishing the at least one advisor decision criterion;
send the updated first input to a decision definition database to determine at least one advisor decision alternative rating based on one or more user inputs;
send the at least one advisor decision criterion to at least one advisor, wherein a first display prompts the at least one advisors to select a rating for the decision alternative inputs in the form of a criteria scale to generate at least one quantitative input;
receive from the advisor at least one advisor feedback in the at least one second input, wherein the advisor feedback is based on the at least one advisor criterion and a review of at least two decision alternatives based on one or more provided inputs by a user and the at the at least one advisor decision assessment based upon at least one decision criterion input;
transmit the advisor feedback to an advisor feedback database for updating the stored advisor feedback associated with the subject and to an AI module;
determine and generate via the AI module, based on the stored advisor feedback of the advisor feedback database, a prioritized advice output including a plurality of decision alternative assessments, wherein each decision alternative assessment is numerically ranked based on a composite of a plurality of decision alternative ratings using a first algorithm to generate a quantitative rating using, wherein an expected value of utility is generated from criterion ratings value per fair market price dollar and a probability of success is derived for each alternative assessment to establish the multi factor ranking across the plurality of decision alternatives to normalize the inputs for a user;
generate a collated summary report from the advisor feedback, wherein the collated summary report includes qualitative inputs and consolidated quantitative information and numerically ranked decision alternatives;
transmit via the network the prioritized advice output and collated summary report to the user including the quantitative rating via the mobile device to the user and qualitative feedback, wherein the mobile device provides the advisor ratings in a comparable quantitative ranking order to select the best option for the decision alternatives based upon the maximum-minimum expected value utility algorithm;
receive, from the user, a decision, based on a selection of the prioritized advice output, and the quantitative rating;
transmit through the network the selected decision to a decision setup database, and update the decision definition database with the selected decision and the advisor feedback; and
transmit the advisor rating to an advisor marketplace database, which stores the advisor rating in association with the advisor and associated feedback advice.

6. The computer implemented method as in claim 5, wherein the decision module is programmed to:
receive an alternative from the user in the first input;
transmit the alternative to an alternative definition database;
transmit the alternative to the advisor;
receive from the advisor an advisor suggested alternative in the at least one second input;
transmit the advisor suggested alternative to an advisor suggested alternatives database; and
execute a command to provide the advisor suggested alternative in the readable summary, wherein the decision modules provides an expected value in the form of a numerical value to establish a quantitative rating of the alternative.

7. The computer implemented method as in claim 6, further comprising an A1 module configured to receive from the user the at least one decision criterion input and generate an additional decision alternative not previously provided by the user.

8. The computer implemented method as in claim 7, wherein the system is openly accessible to both the user and the advisor, wherein the system further include one or more biofeedback sensors, wherein the biofeedback sensor obtain bio feedback data from an advisor during the advisor decision assessment.

9. The computer implemented method as in claim 7, wherein the system is openly accessible to the user and selectively closed to the advisor, wherein the system has a first server for users and a second server for advisors, wherein the first server and second server are communicatively coupled by a central system operator, wherein the first algorithm is a maximum-minimum expected value utility algorithm, wherein the system generates a minimum EV utility value for each decision alternative.

10. The computer implemented method as in claim 5, wherein the system is openly accessible to the user and selectively closed to the advisor, the system including a second enterprise, the second enterprise selective closure to the advisor.

11. A system for providing a user one or more decision alternatives to a decision criterion input, comprising:
a user device includes a memory and a processing unit, the user device accessible to the user and configured for generating a first input from a user;
at least one advisor having a memory and a processing unit,
the at least one advisor device accessible to at least one
advisor and connected in a network with the first remote computing device configured for generating at least one second input;
a decision module executable by a processor configured to receive the first input by the user and the at least one second input by the advisor, and to transmit a plurality of questions related to the first input, wherein the user's one or more inputs to the plurality of questions generate a defined decision criterion;
an AI module communicatively coupled to the decision module;
one or more biometric sensors communicatively coupled to the advisor device; and
a server comprising a central processing unit and a memory, the server hosting the decision module and programmed to:
receive from the user the defined decision criterion requiring advice in the first input;
transmit the user defined decision criteria to a decision definition database;
transmit the user defined decision criteria to the advisor;
receive from the second remote computing device of the advisor an advisor feedback in the at least one second input;
transmit the advisor feedback to an advisor feedback database;
execute a command to utilize the decision module to rank feedback and provide
a readable summary to be displayed to the user, wherein the decision module provides an expected
value in the form of a numerical value to establish a quantitative rating for display on the readable summary, wherein the quantitative rating is directly related to a probability of success using a first algorithm to generate a quantitative rating using a maximum-minimum expected value utility algorithm;
transmit the readable summary to the first remote computing device associated with the user;
receive from the user an input associated with a decision and an advisor rating;
transmit the decision to a decision setup database for future decision criterion inputs;
update the decision criterion database with the input associated with the decision; and
transmit the advisor rating to an advisor marketplace database.

12. The system of claim 11, wherein the server is programmed to:
receive an alternative from the user in the first input;
transmit the alternative to an alternative definition database;
transmit the alternative to the advisor;
receive from the advisor an advisor suggested alternative in the at least one second input;
transmit the advisor suggested alternative to an advisor suggested alternatives database; and
execute a command to provide the advisor suggested alternative in the readable summary, wherein the algorithm provides an expected value in the form of a numerical value to establish a quantitative rating of the alternative.

13. The system of claim 12, wherein the advisor marketplace database, the decision definition database, the advisor feedback database, the decision setup database, the alternative definition database, and the advisor suggested alternative database are hosted on a second server and controlled by an enterprise.

14. The system of claim 10, wherein the system is selectively closed and accessible only members of an enterprise.

15. The system of claim 13, wherein the system is openly accessible to the user and selectively closed to the advisor.

16. The system of claim 13, wherein the system is openly accessible to the user and selectively closed to the advisor, the system including a second enterprise, the second enterprise selective closure to the advisor.
